(19) United States
(12) Patent Application Publication
(10) Pub. No.: US 2004/0021088 A1
(43) Pub. Date: Feb. 5, 2004

(54) Radiation detectors and autoradiographic imaging apparatuses comprising such detectors

(76) Inventors: Dominique Thers, Nantes (FR); Lionel Luquin, La Chapelle/Erdre (FR); Michel Coulon Philippe, Montrouge (FR); Georges Charpak, Paris (FR)

Correspondence Address: MCCRACKEN AND FRANK, 200 W. ADAMS STREET, SUITE 2150, CHICAGO, IL, 60606, US

(21) Appl. No.: 10/385,156

(22) Filed: Mar. 10, 2003

(30) Foreign Application Priority Data
Aug. 3, 2002 (FR) FR02/02978

(51) Int. Cl. G01T 1/18

(52) U.S. Cl. 250/385.1

(57) ABSTRACT

Radiation detector comprising one or more amplifying structures, each comprising an input electrode and an output grid which are kept separated by an insulating spacer. Each spacer defines amplification spaces for generating electrons by the avalanche effect. The dimensions of these amplification spaces are decorrelated with those of the mesh cells of the output grid.

### BACKGROUND OF THE INVENTION

1. Field of the Invention

The present invention relates to radiation detectors and to autoradiographic imaging apparatuses comprising such detectors.

2. Description of the Related Art

More particularly, the invention relates to an ionizing-radiation detector comprising:

a chamber containing a medium suitable for generating electrons under the effect of radiation;

a conversion space in which the radiation generates electrons, this conversion space having a cathode through which the radiation to be detected penetrates;

an anode for generating signals that depend on a current generated by the displacement of charges in the vicinity of this anode, these charges corresponding to electrons and to ions caused directly or indirectly by the radiation;

biasing means that generate an electric field suitable for driving electrons in the direction going from the cathode to the anode;

at least one amplifying structure, located between the cathode and the anode, each amplifying structure comprising an input electrode and an output electrode, the said electrodes being kept separated by an insulating spacer having at least one electron amplification space in which electrons are generated by an avalanche from electrons generated by the radiation, each amplification space having lateral dimensions, in a plane perpendicular to the electric field, greater than the distance separating the input electrode from the output electrode, and each amplification space opening into at least one hole in the output electrode in order to let through at least some of the electrons generated by the avalanche.

A radiation detector with an optimized spatial resolution and/or gain, and with a good operating stability is provided.

### BRIEF SUMMARY OF THE INVENTION

According to an embodiment of the invention, is a detector of the kind in question, characterized in that the lateral dimensions of each amplification space are greater than the dimensions, in a plane perpendicular to the electric field, of each hole in the output electrode into which this amplification space opens.

By virtue of these arrangements, the dead spots due to the presence of the insulating spacer are greatly reduced. Consequently, the field is much more uniform in each amplification space and near the conversion space. Thus, the detectors according to the invention have a better spatial resolution and a higher gain than the detectors of the prior art, but nevertheless maintain excellent operating stability. This stability is possible even with input and output electrodes consisting of very thin grids having a thickness of the order of only a few microns. The exploitation of the electrical properties of the thin grids even contributes to this stability. Thanks to this stability, it is possible to have a high amplification factor, possibly being up to one hundred thousand, thereby making it easier to detect and locate radiation penetrating this detector. Thanks to this stability, it is also possible to eliminate most of the insulating bodies needed for separating the input and output electrodes.

Thus, in the detector according to an embodiment of the invention the spacer is designed to provide, opposite each hole in the output electrode, an amplification space whose cross section perpendicular to the electric field is very much greater than the cross section of this hole. The constituent insulator of the spacer therefore does not block the space located opposite this hole. The electric field generated by the input and output electrodes is thus virtually undistorted. This makes it possible, in particular, to obtain images of very extended objects, for example those 7 centimetres in size, while eliminating most of the masking effects associated with the presence of a spacer.

The information collected at the anode is therefore an image more representative of the ionizing radiation source, thus increasing the spatial resolution of this type of detector. For example, the detector according to the invention makes it possible to obtain a spatial precision of around ten microns over surfaces of 50×50 cm² in size.

In exemplary embodiments of the invention, the radiation detector may optionally furthermore have one or more of the following arrangements:

the input electrode, the output electrode and the spacer consist respectively of independent elements suitable for being disconnected; this allows each of these elements to be optimized, independently of one another, and makes it possible to use, for producing each of these elements, a technique that is appropriate, optimized and/or inexpensive, etc.;

the spacer consists of a sheet of insulating material locally approximately perpendicular to the electric field, perforated right through, in the direction parallel to the electric field, by at least one window open both onto the input electrode and onto the output electrode, each window defining an amplification space having a dimension D perpendicular to the electric field, given by:

$$0.2 \geq y ( \frac{D}{2} ) = \frac{ρ {D}^{2}}{8 N} - \frac{ρ D}{2 N} \sqrt{\frac{EI}{N}} \frac{[ 1 - cos ( \frac{1}{2} \sqrt{\frac{N}{EI}} ) ]}{sin ( \frac{1}{2} \sqrt{\frac{N}{EI}} )}$$

where

$$y ( \frac{D}{2} )$$

is the deflection at the centre of each amplification space;

E is the Young's modulus of the constituent material of the input grid or output grid;

I is the second moment of inertia of a portion of the input grid or output grid, corresponding to the dimensions of each amplification space;

N is the tensile prestress in the input grid or output grid; and

ρ is the electrostatic linear charge of the input electrode or output electrode,

ρ being given by:

$$ρ = [ {ϵ}_{0} {ϵ}_{r} \frac{{U}^{2}}{2 {e}^{2}} ] \cdot \frac{s}{2 l}$$

where

U is the voltage applied between the input grid and the output grid;

ε₀ and εᵣ are the electric constant and the relative permittivity of the medium, respectively;

e is the thickness of the spacer; and

S is the area of the input grid or output grid covering each amplification space; this arrangement makes it possible to optimize the transparency of the spacer, without impairing the gain of the amplifying structure, and makes it easier to assemble the amplifying structure, compared with the use of a spacer consisting of mutually independent balls or fibres; if the spacer has only one window, there are no dead spots at all;

the spacer has at least two windows separated from each other by a bar whose thickness between these two windows is less than or equal to the dimension of this bar parallel to the electric field, which is itself less than or equal to 500 microns; such a spacer has the advantage of limiting the dead spots; however, this arrangement is not limiting and it is possible to design, without departing from the scope of the invention, detectors in which the thickness of a bar between two windows may be greater than or equal to the thickness of this bar parallel to the electric field;

it has an amplifying structure for which the amplification space is coincident with the conversion space, the input electrode of this amplifying structure corresponding to the cathode; this makes it possible for the parallax effects to be greatly reduced and overcomes effects of the trajectory of the incident charged particles, including in the case of charged particles emitted by the tracers conventionally used in biology; thus, the position of the points of emission, whatever the isotopes causing this emission, may be determined very accurately; in this case, the input electrode is advantageously formed from an at least partially conducting face of a specimen that emits ionizing radiation; these arrangements are particularly advantageous when the ionizing radiation source is not collimated, and more particularly still in the case of beta-autoradiography;

it comprises several amplifying structures stacked, between the cathode and the anode, in the direction of the electric field; the output electrode of a first amplifying structure is coincident with the input electrode of a second amplifying structure placed between the first amplifying structure and the anode; in both cases, at least two amplifying structures optionally have different geometries; and

it comprises a spreading space located between the anode and the output electrode opposite the anode, in which space there is an electric field suitable (advantageously less than 10 kV/cm) for spreading, in directions perpendicular to this field, electrons by scattering off the atoms and molecules of the medium contained in the chamber.

The detectors according to embodiments of the invention having several stacked amplifying structures are very clearly distinguished from detectors of the type of those in the prior art that have a stack of insulating plates, the two main faces of which are covered with a conducting material, which plates are perforated with holes and subjected to a potential difference causing an electric field responsible for avalanche multiplication in holes made in these plates. This is because, in the detectors according to the invention, the specific electrical properties of the input and output electrodes, and also the electric fields prevailing on each side of the conducting surfaces of each amplifying structure, may be judiciously chosen. It is thus possible to separate the various amplifying structures, in the direction perpendicular to the electric field, by distances that may be up to one thousand times greater than the distance that usually separates the holes in the perforated plates of detectors of the prior art, while maintaining excellent electrical stability (relative uniformity of the electric field between spacers separated by considerable distances compared with the distance separating the input and output electrodes of the same amplifying structure) and excellent mechanical stability (reduced deformation of the input and output electrodes, the thickness of which is only a few microns).

By virtue of these arrangements, the detector according to the invention makes it possible to produce many structures, for various applications, with successive electron amplifying spaces, with very little material introduced into the said structures compared with the presently known prior art. Parasitic shadow effects or effects that reduce the spatial resolution stemming from this material are thus very greatly reduced.

The input and output electrodes of the amplifying structure of the detector according to an embodiment of the invention consist of grids whose thickness, parallel to the general direction of the electric field between the anode and the cathode, is very much less than the lateral dimensions of the holes in these grids, that is to say in a plane perpendicular to this electric field. By virtue of this arrangement, it is possible to choose the parameters of the electric fields between the various electrodes so that the lines of force on each of the faces of a grid create, on this grid, forces that balance out, at least in part. The thinness of the grids also limits the fraction of the field lines that terminate on the side walls of the holes in the grids and they therefore cannot contribute to the balancing of the grids. All this helps to make this grid stable and thus to keep the input and output electrodes parallel. It is thus possible to limit the mass of insulating material making up the spacer between the input and output electrodes.

Through these arrangements, the detector according to this embodiment of the invention is clearly distinguished from those of the prior art in which the input and output electrodes consist of grids that are thick compared with the distance separating them, or in which the input and output electrodes are deposited on thick insulators and perforated with holes.

According to another aspect of an exemplary embodiment of the invention, the latter relates to an autoradiographic imaging apparatus comprising a detector having one or other of the features indicated above and furthermore having a specimen holder designed so that this detector is placed at least 50 microns from a specimen which emits ionizing radiation and is mounted on the specimen holder.

In exemplary embodiments of this imaging apparatus, the latter has one or more of the following arrangements:

the input electrode consists of an at least partially conducting specimen placed on the specimen holder;

the anode is transparent to the optical signals, this device furthermore comprising an optical read device for reading the signals; and

the anode comprises a plurality of elementary anodes connected to at least one read channel via tracks, each read channel being connected to several elementary anodes.

Further aspects, objects and advantages of the invention will become apparent on reading the description of several of its embodiments.

### BRIEF DESCRIPTION OF THE SEVERAL VIEWS OF THE DRAWINGS

The invention will also be more clearly understood with the aid of the drawings, in which:

FIG. 1 is a schematic section, perpendicular to its main faces, of a first embodiment of the detector according to the invention;

FIG. 2 is a schematic section, in a plane similar to that of FIG. 1, of part of the amplifying structure of the detector shown in FIG. 1;

FIG. 3 is a schematic section, in a plane similar to that of FIGS. 1 and 2, of part of the anode of the detector shown in FIG. 1;

FIG. 4 shows schematically, in perspective, the constituent tiles of the anode shown in FIG. 3;

FIG. 5 shows schematically, as seen from above, the arrangement of the crossed tracks of the anode shown in FIGS. 3 and 4;

FIG. 6 shows schematically the method of connecting the tiles to the tracks of the anode shown in FIGS. 3, 4 and 5;

FIG. 7 is a schematic section, in a plane similar to that of FIG. 1, of a second embodiment of the apparatus according to the invention;

FIG. 8 is a schematic section, in a plane similar to that of FIGS. 1 and 7, of a third embodiment of the detector according to the invention;

FIG. 9 is a schematic section, in a plane similar to that of FIGS. 1, 7 and 8, of a fourth embodiment of the detector according to the invention;

FIG. 10 shows schematically, in perspective, a fifth embodiment of the detector according to the invention; and

FIG. 11 shows schematically, in perspective, an autoradiographic imaging apparatus comprising the detector shown in FIG. 10.

### DETAILED DESCRIPTION OF THE INVENTION

In the various figures, the same references denote identical or similar components.

Five exemplary embodiments of the detector 1 according to the invention will be described below.

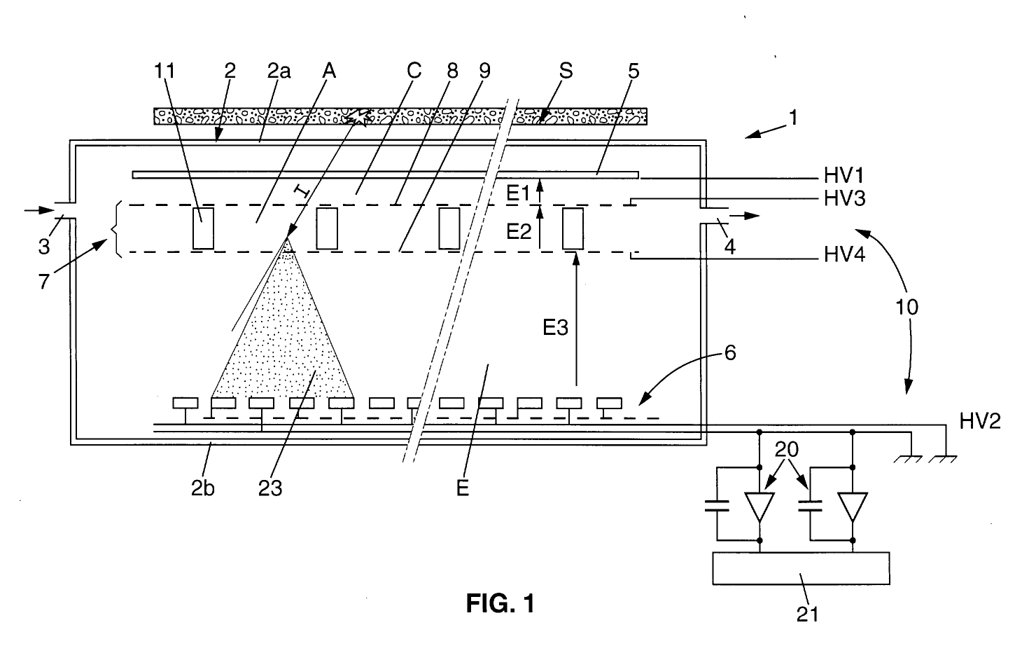

According to the first embodiment, shown in FIG. 1, the detector 1 comprises a flat chamber 2 with two opposed main faces 2a and 2b parallel to each other. This chamber 2 contains a medium suitable for emitting primary electrons under the effect of ionizing radiation emitted by a specimen S placed near one 2a of the main faces 2a, 2b of the chamber 2. Advantageously, this medium consists of a gas flowing between an inlet 3 and an outlet 4.

This gas consists of a mixture comprising a noble gas and organic molecules. These organic molecules are intended to control the avalanche amplification process. They are known to those skilled in the art as “quenchers”.

The gas flowing through the chamber 2 is chosen depending on the application for which the detector 1 is intended, that is to say depending on the particles to be detected, on the read mode, on the detection electronics, etc.

In the particular case of the detection of beta particles, this gas is advantageously at atmospheric pressure (for safety and economic reasons) and comprises a noble gas whose mean electron density is close to 10 electrons per atom, as is the case with neon. When neon is used, the quencher advantageously consists of isobutane, present in the gas mixture in an amount of a few per cent of the number of molecules of this mixture.

The chamber 2 contains a cathode 5, an anode 6 and an amplifying structure 7.

In the embodiment described here, the cathode 5, the anode 6 and the amplifying structure 7 are parallel to one another and parallel to the two main faces 2a, 2b of the chamber 2.

The anode 6 is located close to the face 2b, on the opposite side from the face 2a near which the specimen S is located.

The amplifying structure 7 is located between the cathode 5 and the anode 6. The space in the chamber 2 lying between the cathode 5 and the amplifying structure 7 forms a conversion space C. The ionizing radiation emitted by the specimen S penetrates the conversion space C via the cathode 5.

The space in the chamber 2 lying between the amplifying structure 7 and the anode 6 forms a spreading space E.

The amplifying structure 7 has an input electrode 8 and an output electrode 9, these being parallel to the cathode 5 and to the anode 6 and defining an amplification stage A.

Biasing means 10 are connected to the cathode 5, to the anode 6, to the input electrode 8 and to the output electrode 9. They bring the cathode 5 to a potential HV1, the anode 6 to a potential HV2, the input electrode to a potential HV3 and the output electrode to a potential HV4, these potentials satisfying the following inequality:

HV2>HV4>HV3>HV1.

In the embodiment described here:

the input electrode 8 and output electrode 9 are spaced apart by 125 microns;

the conversion space C and the spreading space E have a length, perpendicular to the input electrode 8 and output electrode 9, of approximately 3 and 4 millimetres, respectively;

the anode 6 is earthed;

the cathode 5 is taken to a negative potential HV1 approximately equal to −3000 volts;

the input electrode 8 is taken to a negative potential HV3 approximately equal to −2100 volts; and

the output electrode 9 is taken to a negative potential HV4 approximately equal to −1600 volts.

The biasing means 10 thus make it possible to create electric fields E1, E2 and E3 in the conversion space C, in the amplification stage A and in the spreading space E, respectively. The biasing means 10 drive the electrons from the cathode 5 to the anode 6.

The cathode 5 consists of a thin electrically conducting plate perforated with small holes. Advantageously, its thickness is approximately equal to 5 microns. Advantageously, the number of holes in the cathode per linear inch is 200 LPI (LPI: Lines per inch).

It may also optionally consist of a woven mesh (less expensive than the one above), a metallized Mylar® foil, an unperforated metal foil (for example made of copper, 10 microns in thickness), a copper-plated adhesive tape bonded to a glass plate using an electrically conductive adhesive (for applications such as autoradiography, for example), a photocathode (optionally coupled to a Cerenkov detector), etc.

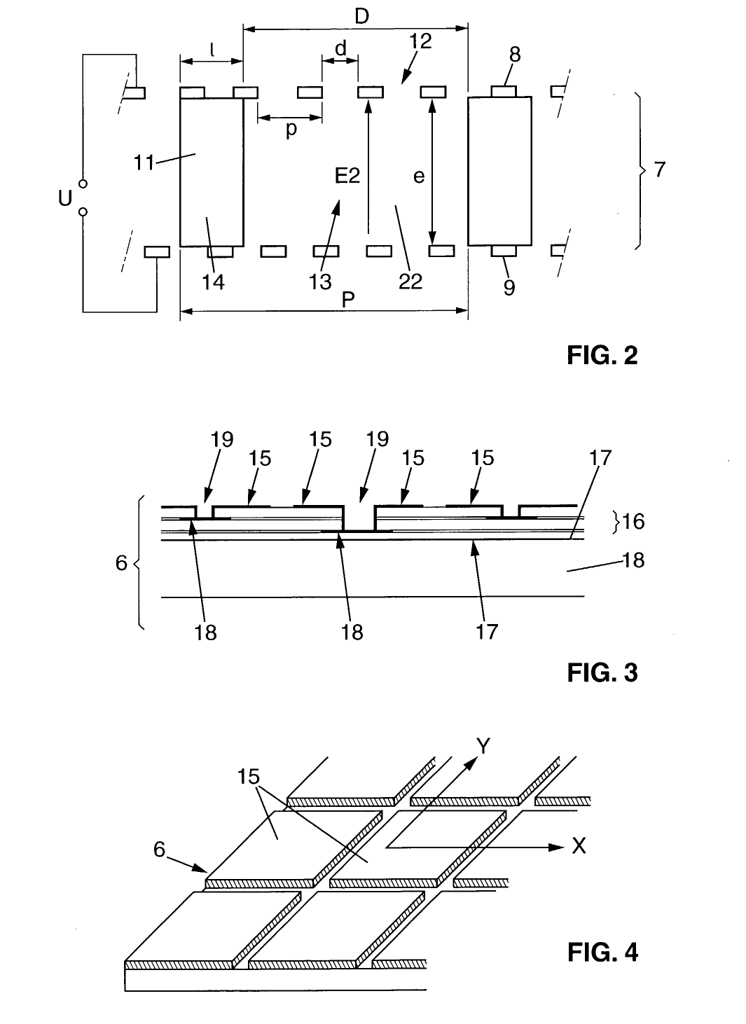

In the amplifying structure 7 shown in FIG. 2, the input electrode 8 and the output electrode 9 are separated by a spacer 11. The input electrode 8, the output electrode 9 and the spacer 11 consist of independent components that can be machined separately from one another. They are assembled and held together in the amplifying structure 7, but they may be easily disconnected from one another, in order to be changed, for example.

The input electrode 8 and the output electrode 9 each consist respectively of a thin electrically conducting plate, of small thickness and perforated with small holes 12. To give an example, the holes 12 are in the form of a square having sides of 39 microns, spaced apart from one another with a pitch p of 50 microns, which corresponds approximately to the number of holes 12 per linear inch being 500 LPI. It is also possible to use input 8 and output 9 electrodes of 2500 LPI, which corresponds approximately to 8-micron holes spaced 10 microns apart. Such input 8 and output 9 electrodes each form a grid which, on account of the small size of the holes 12, may be termed a “micromesh”. Such micromeshes have already been disclosed, for example, in document EP 855 086.

The spacer 11 consists of a grid formed from an insulating material whose dielectric permittivity is between 2 and 5. This grid consists, for example, of a sheet of Kapton® advantageously having a thickness of less than 500 microns and preferably less than 300 microns, perforated with square windows 13 cut by means of a laser or by etching and separated by bars 14. In the amplifying structure 7, when the input electrode 8, the output electrode 9 and the spacer 11 are assembled, the windows 13 open onto the input electrode 8 and the output electrode 9. However, the respective holes 12 in the input electrode 8 and output electrode 9 are not necessarily aligned in the direction of the electric fields E1, E2 and E3. Thus, the fact of not having to align the respective holes 12 of the input electrode 8 and output electrode 9 constitutes an advantage of the invention. The volume bounded by the bars 14 of a window 13, the input electrode 8 and the output electrode 9 forms an amplification space 22. The amplification stage A consists of one or more amplification spaces 22, depending on whether the spacer 11 has one or more windows 13. In a plane perpendicular to the electric field E2, the dimensions of the windows 13 are greater than the dimensions of the holes 12 in the input electrode 8 and output electrode 9, which open onto the amplification spaces 22. To give an example, the width 1 of these bars 14, between two windows 13, in the plane of the constituent sheet of the spacer, is less than 100 microns and the bars are separated from one another with a pitch p of less than 5 cm.

The distance between two bars is determined according to the bending of the input electrode 8 and output electrode 9 under the effect of the electric field generated by the potential difference U to which they are subjected. It is estimated that the local deflection y undergone by the input electrode 8 and the output electrode 9 is tolerable if it entails no variation in the gain of the amplifying structure 7 of more than 10% (this tolerance depends on the applications envisaged for the detector 1). If it is estimated that this deflection y, at the centre of the distance D separating two bars, must not be greater than 20%, in order for the variations in the gain of the amplifying structure 7 to be tolerable, the distance D must satisfy the inequality:

$$0.2 \geq y ( \frac{D}{2} ) = \frac{ρ {D}^{2}}{8 N} - \frac{ρ D}{2 N} \sqrt{\frac{EI}{N}} \frac{[ 1 - cos ( \frac{1}{2} \sqrt{\frac{N}{EI}} ) ]}{sin ( \frac{1}{2} \sqrt{\frac{N}{EI}} )}$$

where

$$y ( \frac{D}{2} )$$

is the deflection at the centre of each amplification space 22;

E is the Young's modulus of the constituent material of the input grid 8 or output grid 9;

I is the second moment of inertia of a portion of the input grid 8 or output grid 9, corresponding to the dimensions of each amplification space 22;

N is the tensile prestress in the input grid 8 or output grid 9; and

ρ is the electrostatic linear charge of the input electrode 8 or output electrode 9,

ρ being given by:

$$ρ = [ {ϵ}_{0} {ϵ}_{r} \frac{{U}^{2}}{2 {e}^{2}} ] \cdot \frac{s}{2 l}$$

where

U is the voltage applied between the input grid 8 and the output grid 9;

ε₀ and εᵣ are the electric constant and the relative permittivity of the medium, respectively;

e is the thickness of the spacer; and

S is the area of the input grid 8 or output grid 9 covering each amplification space 22.

It may be noted that the determination of the deflection

$$y ( \frac{D}{2} )$$

by the above relationship gives an overestimate for this deflection. In other words, it is possible to design a high-performance detector 1 even if the distance D is equal to, or indeed greater than, that given by the above inequality.

The optical opacity of such a spacer 11 is advantageously less than 30% and preferably less than 1%.

As shown in FIG. 3, the anode 6 has a planar multilayer structure. It comprises an external layer 15, two internal layers 16 and an earth plane 17, this all resting on an insulating substrate 28.

As shown in FIG. 4, the external layer 16 is segmented into elementary anodes or tiles 15 forming a two-dimensional draught-board array, the rows of which are aligned with the coordinate axes X and Y. Each tile 15 forms a square with sides of less than 1 millimetre, for example 650 microns. The tiles 15 are assigned alternately to reading one or other of the coordinates X and Y. Two adjacent tiles 15 do not measure the position along the same coordinate. The space between the tiles 15 is as small as possible, but must make it possible to maintain perfect insulation between them. Advantageously, this space is less than 100 microns.

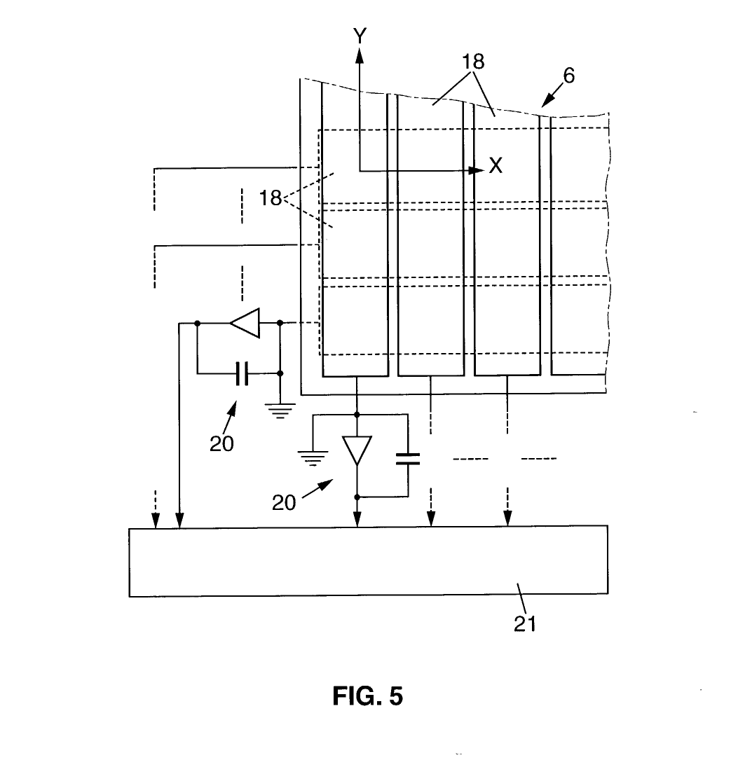

As shown in FIG. 5, the internal layers 16 are formed from crossed conducting tracks 18. On one of the internal layers 16, the tracks 18 lie parallel with first rows of tiles 15. On the other of the internal layers 16, the tracks 18 lie parallel to second rows of tiles 15, perpendicular to the first rows. According to this example, the tiles 15 of a row associated with the coordinate X are located on an internal layer different from that connected to the tiles placed on a row corresponding to the coordinate Y. The tracks 18 are separated from the tiles 15 by an insulator perforated with via holes 19 plated with an electrically conducting material so as to ensure that the tiles 15 are electrically connected to the tracks 18 of one or other of the internal layers 16 (see FIG. 3). The via holes 19 have a diameter of 100 microns, for example.

The tracks 18 are separated from one another by the shortest possible distance, while maintaining perfect insulation between them. The fact of placing the tracks on superposed layers insulated from one another increases the level of integration, while maintaining the required quality of insulation.

The tiles 15, thanks to the tracks 18, are connected to high-speed amplifiers 20 which are themselves connected, via electronic read channels, to electronic processing means 21 (see FIG. 5).

To limit the number of electronic read channels, and consequently the cost of the detector 1, several tiles 15 belonging to the same row are connected to the same track 18. The number of tiles 15 separating two tiles connected together depends on their size and on the technology used to produce them.

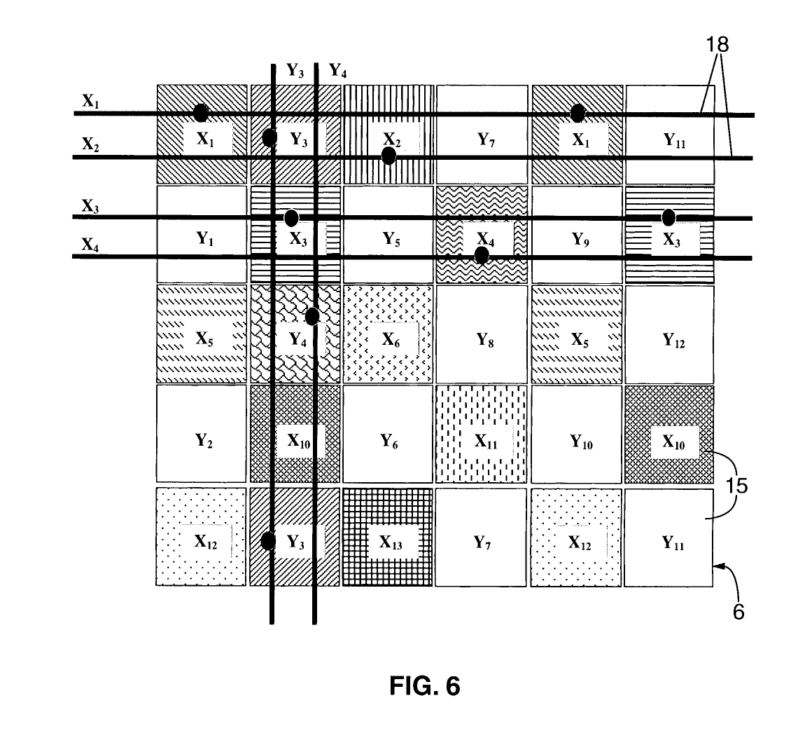

To give an example, and as shown in FIG. 6, each track 18, within one row, connects with one tile 15 in four in a periodic manner. Since two adjacent tiles are connected to tracks 18 lying along the X and Y axes, respectively, a track X1 connects two tiles separated by three tiles, these three tiles comprising two adjacent tiles of the two tiles connected to the track X1, that are themselves connected to the tracks Y1 and Y7, respectively, and are separated by a tile connected to a track X2, this arrangement being repeated over the entire draught-board formed by the tiles 15 (in FIG. 6, two tiles 15 connected together are indicated by identical patterns).

When an ionizing particle I is emitted by the specimen S and it penetrates the detector 1 via that face 2a of the latter on the opposite side from the side close to the anode 6, it passes through the conversion space C in which it interacts with the gas and generates primary electrons. Under the effect of the electric field E1, these primary electrons reach the amplification stage A in which they are multiplied by an avalanche effect, to form an electron cloud 23 (see FIG. 1).

Part of this electron cloud 23 then passes through the output electrode 9 and penetrates the spreading space E. The electric field E3 in the spreading space E is moderate (<10 kV/cm) and propitious for spreading the electron cloud 23 laterally by the electrons constituting the cloud being scattered off the atoms and molecules of the gas. The thickness of the spreading space, in the direction of the electric field E3, the nature of the gas and the size of the tiles are determined so that the spatial extension of the electron cloud 23, at the anode 6, covers several tiles 15 (at least two in each direction of the coordinates X and Y) and so that it is possible thus to determine the centre of mass of the electron cloud 23. The isobutane makes it possible to stabilize the avalanche process and obtain scattering in the spreading space E such that the avalanche spreads over a sufficient number of tiles 15 to allow the centre of mass of the electron cloud 23 to be determined.

A current is then induced in a small group of tiles 15 and transmitted, via several electronic channels, to the electronic read means 21. Thus, the position of each avalanche is determined in each coordinate X or Y. After coarse determination of the position of the avalanche, by identifying the rows 18 associated with the coordinates X and Y in question, the charge distributions measured on each tile 15 are used to recalculate the position of the point of emission 24 of the original ionizing radiation. A precise measurement of this position may be obtained after correcting the geometrical distortions due to the weighting method used to determine the centre of mass of the electron cloud 23 interacting with the tiles 15 over which the measurement is made.

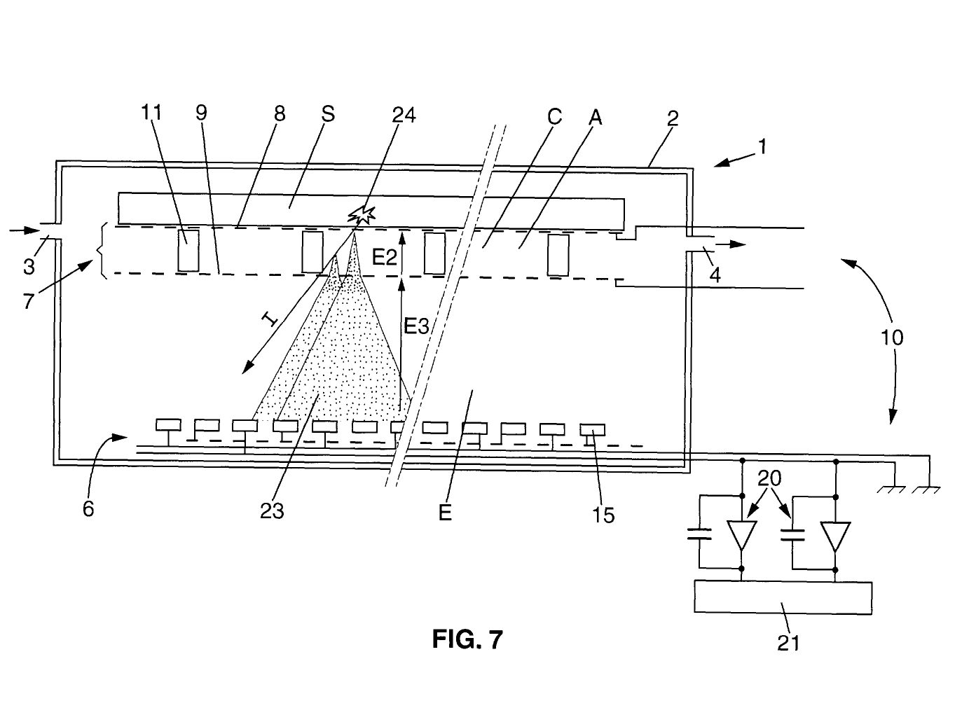

A second embodiment of the detector 1 according to the invention is shown in FIG. 7. This differs from the first embodiment described above essentially by the fact that the conversion space C and the amplification stage A are coincident here. In this case, the detector 1 has a cathode 5 coincident with the input electrode 8 and the specimen S is placed directly near the input electrode 8 of the amplifying structure 7. The input electrode 8 acts as cathode.

The biasing means 10 make it possible to create electric fields E2 and E3 in the amplification stage A and in the spreading space E, respectively. The biasing means 10 drive the electrons from the input electrode 8 to the anode 6.

In this embodiment, the amplifying structure 7 has a thickness, parallel to the electric field E2, of less than 300 microns. The spacer 11, defining the thickness of the amplification stage A, is matched to the shape of the specimen S.

The specimen S emits an ionizing particle I. This interacts with the gas mixture to generate primary ionization electrons. For the particular case of beta particle detection, a compromise has to be found between, on the one hand, a gas mixture heavy enough for the beta particles to interact and, on the other hand, a gas mixture light enough for the amplification gain to be high enough to allow reading on an anode like that described in relation to the first embodiment. Measurements have shown that this compromise may be achieved using a gas mixture at atmospheric pressure comprising neon and a few per cent of isobutane.

A high electric field E2, greater than 25 kV/cm, is applied in the amplifying structure 7, which allows the primary ionization electrons to be multiplied. With an amplifying structure 7 as described in relation to the first embodiment, it is possible to obtain gains of greater than 100,000 in a proportional regime.

As in the case of the first embodiment described above, the electrons multiplied in the amplifying structure are driven by the field E3 in the spreading space before creating a current in the tiles 15 of the anode 6.

In such a detector 1, it is the electrons created near the cathode, that is to say near the specimen S, which are preferentially multiplied and the parallax effects arising from the isotope emission of the emitting sources of the specimen S are greatly reduced. Such a detector 1 also makes it possible to overcome the effects of the trajectory of the incident particles in the gas, including the high-energy particles such as those conventionally emitted by the isotope tracers used in biology. This detector 1 thus makes it possible to locate very accurately the position of the points of ionizing radiation emission 24, whatever the isotope tracers used. The detector 1 makes it possible to obtain distribution curves indicating the position of the point sources, with a mid-height width of less than 100 microns.

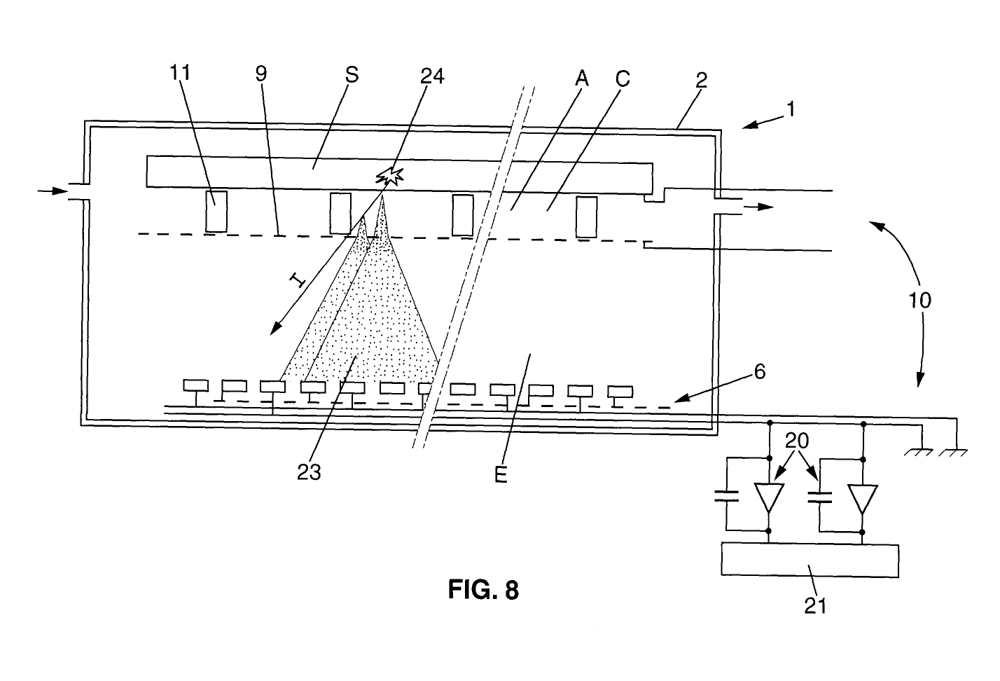

A third embodiment of the detector 1 according to the invention is shown in FIG. 8. This differs from the second embodiment described above essentially by the fact that the input electrode is replaced with one face of the specimen S, this face possibly being metallized in order to make it conducting or biased via the rear when it is partially conducting. In this case, the detector 1 does not have an independent cathode 5 and it is the specimen S that acts as cathode.

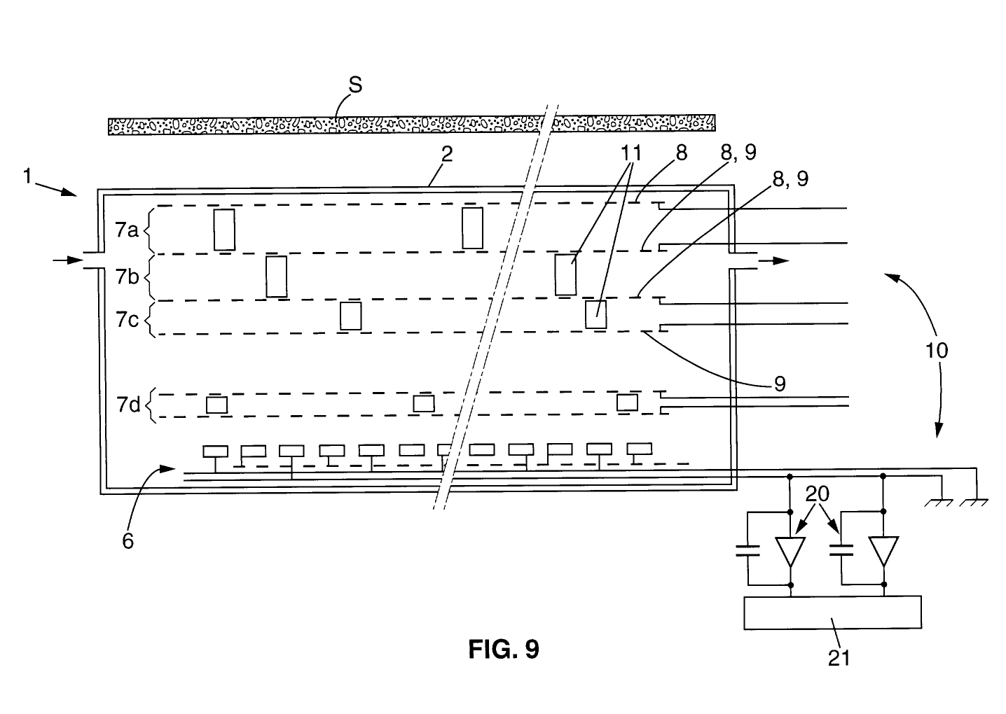

A fourth embodiment of the detector 1 according to the invention is shown in FIG. 9. This differs from the second embodiment described above essentially by the fact that it has several amplifying structures 7a, 7b and 7c similar to the amplifying structure 7 already described in relation to the second embodiment, but superposed so that the input electrode 8 of the amplifying structure 7b is coincident with the output electrode 9 of the amplifying structure 7a on which it is superposed, and so on for the subjacent amplifying structure.

In the embodiment shown in FIG. 9, the detector 1 also has another amplifying structure 7d, located between the stack of the amplifying structures 7a, 7b and 7c and the anode 6.

The amplifying structures 7a, 7b, 7c and 7d of this embodiment may be identical to one another or they may be of different geometries.

Many combinations of the stacks described above may be devised, within the context of the invention, depending on the envisaged application. The choice of whether to introduce one amplifying structure or several different amplifying structures into the detector 1 depends on the application for which the detector 1 is intended. Thus, the use of several superposed amplifying structures is particularly advantageous for allowing isotope separation of the tracers in autoradiography, in order to limit discharge phenomena when detecting high-energy particles, or to obtain higher gains with incident radiation such as X-rays.

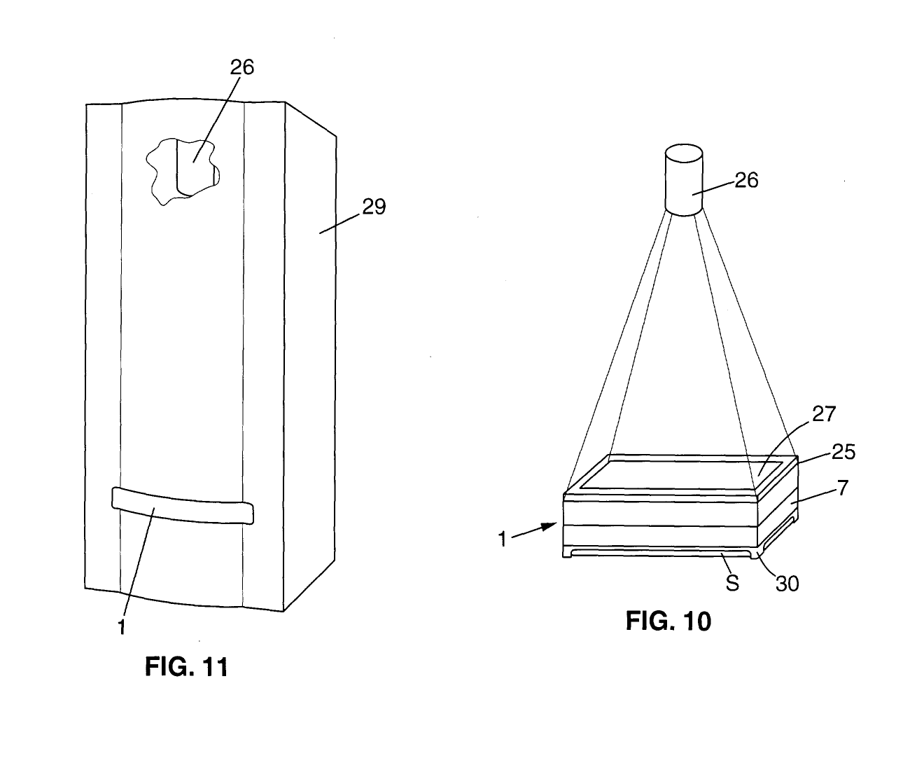

A fifth embodiment of the detector 1 according to the invention is shown in FIG. 10. This differs from the embodiments already described above essentially by the fact that the anode 6 as described above is replaced with a conducting grid 25 of high transparency (advantageously greater than 80%). This grid 25 consists, for example, of a flat plate perforated with holes or of a woven mesh. In this embodiment, the amplifying structure is associated with optical reading of the scintillation light emitted during the amplification process by the electrons interacting with the gas mixture contained in the detector 1. To do this, it is necessary to use one particular quencher, such as for example triethylamine, which emits around a wavelength of 280 nanometres. This wavelength is compatible with the transparency of the optics (for example made of quartz or fluorspar) and the spectral sensitivity of the usual photocathodes of the image intensifiers generally used for reading by a CCD camera.

Advantageously, the autoradiographic imaging apparatus 29 comprises a specimen holder 30 suitable for the detector 1 to be placed at least 50 microns from the specimen S emitting ionizing radiation, mounted on this specimen holder. In this case, the input electrode is advantageously formed by an at least partially electrically conducting (possibly metallized) face of the specimen S placed on the specimen holder 30.

The grid 25 allows a potential to be applied, while letting the scintillation light pass through it. This scintillation light is collected, by a CCD camera 26 coupled to a light intensifier, through an output window 27. This output window is transparent to the wavelengths emitted and closes off the detector 1.

By calculating the centre of mass of the luminous spot created by each avalanche, it is possible to determine, as in the case of the abovementioned detection by tiles, the position of the point of emission 24 of the initial ionizing particle I.

FIG. 11 shows schematically an autoradiographic imaging apparatus 29 comprising a detector 1 according to the fifth embodiment described above. According to a variant, the detector 1 of this imaging apparatus is replaced with a detector 1 such as those described in relation to the first, second, third or fourth embodiments.

What is claimed:

1. Radiation detector comprising:
a chamber containing a medium suitable for generating electrons under the effect of radiation;
a conversion space in which the radiation generates electrons, this conversion space having a cathode through which the radiation to be detected penetrates;
an anode for generating signals that depend on a current generated by the displacement of charges in the vicinity of this anode, these charges corresponding to electrons and to ions caused directly or indirectly by the radiation;
biasing means that generate an electric field suitable for driving electrons in the direction going from the cathode to the anode;
at least one amplifying structure, located between the cathode and the anode, each amplifying structure comprising an input electrode and an output electrode, the said electrodes being kept separated by an insulating spacer having at least one electron amplification space in which electrons are generated by an avalanche from electrons generated by the radiation, each amplification space having lateral dimensions, in a plane perpendicular to the electric field, greater than the distance separating the input electrode from the output electrode, and each amplification space opening into at least one hole in the output electrode in order to let through at least some of the electrons generated by the avalanche,
characterized in that the lateral dimensions of each amplification space are greater than the dimensions, in a plane perpendicular to the electric field, of each hole in the output electrode into which this amplification space opens.

2. Detector according to claim 1, in which the input electrode, the output electrode and the spacer consist respectively of independent elements suitable for being disconnected.

3. Detector according to claim 1, in which the spacer consists of a sheet of insulating material locally approximately perpendicular to the electric field, perforated right through, in the direction parallel to the electric field, by at least one window open both onto the input electrode and onto the output electrode, each window defining an amplification space having a dimension D, perpendicular to the electric field, given by:
$$0.2 \geq y ( \frac{D}{2} ) = \frac{ρ {D}^{2}}{8 N} - \frac{ρ D}{2 N} \sqrt{\frac{EI}{N}} \frac{[ 1 - cos ( \frac{1}{2} \sqrt{\frac{N}{EI}} ) ]}{sin ( \frac{1}{2} \sqrt{\frac{N}{EI}} )}$$
where
$$y ( \frac{D}{2} )$$
is the deflection at the centre of each amplification space;
E is the Young's modulus of the constituent material of the input grid or output grid;
I is the second moment of inertia of a portion of the input grid or output grid, corresponding to the dimensions of each amplification space;
N is the tensile prestress in the input grid or output grid; and
ρ is the electrostatic linear charge of the input electrode or output electrode,
ρ being given by:
$$ρ = [ {ϵ}_{0} {ϵ}_{r} \frac{{U}^{2}}{2 {e}^{2}} ] \cdot \frac{s}{2 l}$$
where
U is the voltage applied between the input grid and the output grid;
ε₀ and εᵣ are the electric constant and the relative permittivity of the medium, respectively;
e is the thickness of the spacer; and
S is the area of the input grid or output grid covering each amplification space.

4. Detector according to claim 3, in which the spacer has at least two windows separated from each other by a bar whose thickness between these two windows is less than or equal to the dimension of this bar parallel to the electric field, which is itself less than or equal to 500 microns.

5. Detector according to claim 1, having an amplifying structure for which the amplification space is coincident with the conversion space, the input electrode of this amplifying structure corresponding to the cathode.

6. Detector according to claim 5, in which the input electrode is formed from an at least partially conducting face of a radiation-emitting specimen.

7. Detector according to claim 1, comprising several amplifying structures stacked, between the cathode and the anode, in the direction of the electric field.

8. Detector according to claim 7, in which the output electrode of a first amplifying structure is coincident with the input electrode of a second amplifying structure placed between the first amplifying structure and the anode.

9. Detector according to claim 7, in which at least two amplifying structures have different geometries.

10. Detector according to claim 1, comprising a spreading space located between the anode and the output electrode opposite the anode, in which space there is an electric field suitable for spreading, in directions perpendicular to this field, electrons by scattering off the atoms and molecules of the medium contained in the chamber.

11. Autoradiographic imaging apparatus comprising a detector according to claim 1 and a specimen holder designed so that the detector is placed at least 50 microns from a specimen which emits radiation and is mounted on the specimen holder.

12. Apparatus according to claim 11, in which the input electrode consists of an at least partially conducting specimen plated on the specimen holder.

13. Apparatus according to claim 11, in which the anode is transparent to the optical signals, this device furthermore comprising an optical read device for reading these signals.

14. Apparatus according to claim 11, in which the anode comprises a plurality of elementary anodes connected to at least one read channel via tracks, each read channel being connected to several elementary anodes.
